(19) United States
(12) Patent Application Publication
(10) Pub. No.: US 2009/0183840 A1
(43) Pub. Date: Jul. 23, 2009

(54) SYSTEM FOR DIVIDING OFF AREAS OF A ROOM

(75) Inventor: Moritz Muehlebach, Dietlikon (CH)

Correspondence Address: ROBERTS MLOTKOWSKI SAFRAN & COLE, P.C.;Intellectual Property Department, P.O. Box 10064, MCLEAN, VA, 22102-8064, US

(73) Assignee: PROVERUM AG, Baar (CH)

(21) Appl. No.: 12/297,996

(22) PCT Filed: Apr. 21, 2006
(86) PCT No.: PCT/EP2006/003703

§ 371 Date: Mar. 2, 2009

(51) Int. Cl. E06B 9/00; A44B 21/00

(52) U.S. Cl. 160/87; 160/127; 24/304

(57) ABSTRACT

A device for dividing off areas of a space, with at least one ceiling rail and/or floor rail and/or wall rail, with at least one web of film or fabric which can be connected to the ceiling rail and/or floor rail and/or wall rail, and with at least one support rod for placement between the ceiling rail and/or floor rail and/or wall rail. It is provided that, on the lengthwise side of the support rod, there is at least one surface element which has a fastening surface for a web of film or fabric, the surface element having at least one fastening means or attaching the web of film or fabric to the fastening surface and the surface element being aligned such that the fastening surface is located essentially perpendicular to the floor of the area of space which is to be divided off.

### BACKGROUND OF THE INVENTION

1. Field of Invention

The invention relates to a device for dividing off areas of a space with at least one ceiling rail and/or floor rail and/or wall rail, with at least one web of film or fabric which can be connected to the ceiling rail and/or floor rail and/or wall rail, and with at least one support rod for placement between the ceiling rail and/or floor rail and/or wall rail.

2. Description of Related Art

A device of the initially mentioned type is already known from International Patent Application Publication WO 2006/002705 A1. In the known device, the individual rails for the ceiling, walls and floor are made such that they can be pushed relative to one another. The rail parts which can be telescoped into and out of one another make it possible to completely divide off one area of a space which is to be renovated relative to other areas of the space. The individual rail parts can form a peripheral frame which adjoins the ceiling, the walls and floor and to which a film can be attached in order to enable dirt-proof separation of the areas of the space. Continuous adjustment of the individual rails is possible in that there are two different types of rail profiles, one profile engaging the other profile and the profiles, in this way, being movable relative to one another. The rail profiles are then screwed to set a certain rail length.

### SUMMARY OF THE INVENTION

A primary object of this invention is to develop a device of the above described type, for dirt-proof dividing off of areas of a space, which will easily achieve high tightness.

This object is achieved in accordance with the invention by a device of the initially mentioned type in which there is at least one surface element on the lengthwise side of the support rod which has a fastening surface for the web of film or fabric, the surface element having at least a fastening means for attaching the web of film or cloth to the fastening surface with the surface element being aligned such that the fastening surface is located essentially perpendicular to the floor of the space which is to be divided off. The surface element which is provided in accordance with the invention is used to attach the web of film or fabric to the support rod, and the term support rod for the purposes of the invention can relate, on the one hand, to a support brace which is located vertically between a ceiling rail and a floor rail, and on the other had, moreover, can also encompass diagonal braces which can, preferably, be detachably fastened to the wall rail on one end and to a floor rail or a ceiling rail at the other end for applying a contact force to the rails.

In accordance with the invention, it is provided that, in addition to the attachment of the web of film or fabric to the rails, the web of film or fabric is attached to at least one surface element of a support rod. Additional attachment points can largely preclude tearing of the web of film or fabric off the rails, for example, by side and transverse winds acting against the web of film or fabric in the divided-off area of the space. For this purpose, the surface element has a fastening surface and at least one fastening means to attach the web of film or fabric to the fastening surface. The fastening surface is aligned essentially parallel to the lengthwise axis of the ceiling rail and/or the floor rail and/or the wall rail so that the web of film or fabric can hang down essentially evenly from the ceiling, and in this case, is fixed to the rails, on the one hand, and the surface element or support rod, on the other.

Preferably, the surface element is adjustable in height and/or is detachably connected to the support rod. For example, surface elements of the type under consideration can be provided wherever increased mechanical loading of the web of film or fabric which has been attached to the ceiling rail and/or floor rail and/or the wall rail can be expected, for example, as a result of side winds or cross winds.

To avoid tearing of the web of film or fabric when areas of a space are being divided off, it can be provided that the surface element has rounded edges at least in the region of the fastening surface.

In order to make available a relatively large fastening surface, it can be provided that the surface element be made dish-shaped or plate-shaped, and the fastening surface should be provided at least in the area of the edge of the dish or edge of the plate. However, fundamentally, it is also possible for the entire outer side of the surface element to serve as a fastening surface for the web of film or fabric. In this way, an especially secure attachment of the web of film or fabric to the support rod can be achieved.

To attach the web of film or fabric to the support rod, the front of the fastening surface can have a layer of adhesive so that the web of film or fabric can be adhered to it by pressing from the outside against the fastening surface. In this connection, it can be provided that the fastening surface has a plurality of adhesive strips which enables repeated cementing of a web of film or fabric, and thus, repeated use of the surface element for fixing the web of film or fabric on the support rod. The surface element can also have fastening surfaces for the web of film or fabric on the front and back, so that the surface element can be used on both sides. However, this assumes that the surface element can be attached with both outer sides, if necessary, to the support rod.

In order to fix the surface element on the support rod, there is at least one connecting means for detachable positive and/or nonpositive joining of the surface element to the support rod. A magnetic connection is also possible. If the fastening surface is on the front of the surface element, there can be connecting means for joining the surface element to the support rod, preferably, on the back of the surface element. The support rod and the surface element can be connected by a catch connection, squeeze connection or a VELCRO® hook-and-loop type connection. Here, embodiments of catch, squeeze and VELCRO® hook-and-loop type connections known from the prior art can be used.

In one preferred embodiment, it is provided that the surface element is made in several parts and has at least two fastening parts which can be braced relative to one another; preferably, the two fastening parts, on each of facing sides, has a fastening surface for the web of film or fabric. In this way, the web of film or fabric can be clamped and/or adhered between the fastening parts. For example, the fastening part can be made dish-shaped with a conical ring shell as the edge of the dish and with a flat base plate as the bottom of the disk, and the fastening surface can be preferably in the region of the edge of the dish.

In this connection, it can also be provided that the fastening part is made elastic or resilient in the region of the edge of the dish. If the fastening parts are braced relative to one another in the axial direction, deformation of the fastening parts occurs in the edge region; this leads to especially secure attachment of the web of film or fabric between the fastening parts. For bracing the fastening parts relative to one another, there can be a screw fitting, catch fitting or quarter-turn fastener fitting. In this way, simple and quick clamping or the web of film or fabric between the fastening parts is enabled. There can also be a magnetic connection.

The fastening parts can have an elastic coating and/or a coating with low indentation hardness, and preferably, the coating can be provided in the edge region of the fastening parts. The coating can be a foam layer which can fundamentally also blanket the fastening surface. The low indentation hardness of a foam coating also contributes to the web of film or fabric being able to be clamped reliably and securely between the fastening parts. Otherwise, by using a foam coating damage to the web of film or fabric during clamping can be prevented.

For a multipart execution of the surface element, at least one fastening part has connecting means for detachable positive and/or nonpositive joining of this fastening part to the support rod. The second fastening part is then braced after joining the first fastening part to the support rod against the first fastening part, the web of film or fabric being clamped between the fastening parts and thus being securely attached to the support rod.

The surface element can be made of plastic; this contributes to very low production costs of the device in accordance with the invention.

For placement between the ceiling rail and the floor rail, the support rod can be made especially continuously adjustable so that sufficient contact pressure between the opposite rails is ensured. For reasons of handling, it is recommended that the rod can be fixed in any set length by way of a screw fitting. For simplified connection to the rails on their upper and/or lower end, the support rod can have connecting means for positive and/or nonpositive connection of the support rod to further complementary connecting means of the rail, the connecting means of the support rod and the other connecting means of the rail being made such that only by turning the support rod around its lengthwise axis is a frictional connection and/or a force fit in the profile effected. In this way especially simple bracing of the support rod between opposing rails is possible.

The features of the above described type, which relate to the support rod as such, and the following features of the support rod, have their own inventive importance, i.e. independently of the above described features which relate to the surface element.

In one embodiment of the invention, it can be provided that the support rod has a fastening part on one end and is pivotally connected to the fastening part, the fastening part having connecting means for positive and/or nonpositive connection to further complementary connecting means of the rail, and preferably, the connecting means of the fastening part and the other connecting means of the rail being made such that only by twisting the fastening part around its lengthwise axis is a frictional connection and/or a force fit in the profile of the rail effected. Since the fastening part has been connected to the rail, it is possible to pivot the support rod relative to the fastening part. In this way, the bracing of the support rod between two opposing rails is simplified. Here, it can be provided that the support rod is attached on one end with the fastening part to the rail and on the other end has connecting means which makes it possible to effect a frictional connection and/or a force fit in the profile of the rail by turning the support rod around its lengthwise axis on the other end of the support rod. The material execution of the support rod or fastening part, on the one hand, and the rail, on the other, which execution is necessary for this purpose, is described below simply using the example of the support rod. It goes without saying that the described features can be provided accordingly in a fastening part.

In one preferred embodiment, there is at least one projection on the end of the support rod that serves as the connecting means and it can be fixed in the rail by turning the support rod around its lengthwise axis in the engagement region as a further complementary connecting means. In this way, a positive and nonpositive connection between the support rod and the rail is easily enabled. In this connection, it is of course possible for the support rod to have the corresponding connections on both ends. If the head and foot of the support rod are made the same, the support rod can be connected by either end to the rail; this further facilitates mounting of the device in accordance with the invention. Moreover, it is preferably provided that the support rod can be inserted or screwed into the engagement region of the rail anywhere on the rail; this further simplifies installation.

In an especially simple and economical embodiment, it is provided that the first rail part is made U-shaped in cross section with two opposite side walls and that preferably the engagement region for the support rod is formed between the bottom of the rail part which connects the side walls and opposite extensions which are provided on the inner side of the side walls. The extensions extend in the lengthwise direction of the first rail part especially over the entire length so that the support rod in the lengthwise direction of the rail part can be connected to it at any location.

On the projection of the support rod, there can be outer feed bevels which run in the shape of an arc segment. In this way, it is possible to connect the support rod to a rail or to brace it in the rail by screwing it in with a low expenditure of force.

The support rod on the opposite jacket sides can have at least one projection which is molded to the support rod, the opposite projections being located in a common plane and spanning a common cross-sectional area with two straight outer sides which are located oppositely parallel and with two arc segment-shaped outer sides which are located diagonally opposite. Moreover, the cross-sectional area which has been fixed by the contour of the projections can have two diagonally opposite edges with outer sides which run essentially at a right angle to one another, after connecting the support rod to the rail by turning the support rod around its lengthwise axis at least the edges of the projections lying against the side walls; this leads to clamping of the support rod in the rail. In order to enable simple insertion of the support rod with one end into the rail, the maximum width of the cross-sectional area corresponds essentially to the distance between adjacent side walls of the rail, and the minimum width of the cross-sectional area should be smaller than the distance between the above described extensions or the other projections on the rail.

In the support rod, preferably on at least one end of the support rod, there can be at least one spring means which acts in the lengthwise direction of the support rod. This spring means facilitates not only insertion of the support rod, but also ensures permanent pressing of the pertinent rail.

In order to be able to easily and quickly mount the support rod, it can be alternatively provided that the support rod with its lower end can be locked into the floor rail and/or the support rod with its upper end can be locked into the ceiling rail. It is preferred if an end of the support rod can be locked into a rail, while with the other end it can be inserted into the corresponding guide of the other rail. It is more favorable here that the upper head of the support rod can be inserted into the guide of the ceiling rail and can be locked in with the other end. In order to enable insertion at different locations and not only on the end of the respective ceiling rail, it is otherwise provided that the guide is interrupted and at the interruption there is at least one insertion opening via which the head of the support rod can be inserted into the guide.

In order to be able to insert the device in accordance with the invention in the region of inclines as well, the head of the support rod can be made such that in the state inserted into the rail the latter can pivot relative to the its lengthwise direction on either side by at least 20°, preferably by more than 40°, relative to the support rod. Specifically this is possible by the head of the support rod being beveled or rounded on the top in the lengthwise direction of the rail.

In particular, there are a host of possibilities for embodying and developing the device in accordance with the invention, as will be apparent from the following description of preferred embodiments of the invention with reference to the drawings.

### BRIEF DESCRIPTION OF THE DRAWINGS

FIG. 1 is a perspective view of the device in accordance with the invention,

FIG. 2 is a perspective view of a base profile of a ceiling rail, floor rail or wall rail which is shown in FIG. 1;

FIG. 3 is a perspective view of a support rod which has been inserted into the base profile which is shown in FIG. 2, the support rod being made as a diagonal brace,

FIG. 4 is a view of the lower end of the support rod,

FIG. 5 is a side view of the end of the support rod shown in FIG. 4,

FIG. 6 is a view of the head of a support rod,

FIG. 7 is a side view of the head of the support rod from FIG. 6,

FIG. 8 is a partial cross-sectional view of a support rod which is connected to the rail, from the side,

FIG. 9 is a partial cross-sectional view of the support rod which is connected to a rail, from overhead,

FIG. 10 is a partial cross-sectional view of the support rod which is connected to a rail in the region of the lower end of the support rod,

FIG. 11 is a partial cross-sectional view of the end of the support rod shown in FIG. 10, from the side,

FIG. 12 is a cross-sectional view of the end of the support rod taken along line A-A in FIG. 10,

FIG. 13 is a cross-sectional view from overhead showing a first embodiment of a surface element attached to the support rod of the device of FIG. 1, and

FIG. 14 is a cross-sectional view from overhead showing a second embodiment of a surface element attached to the support rod of the device of FIG. 1.

### DETAILED DESCRIPTION OF THE INVENTION

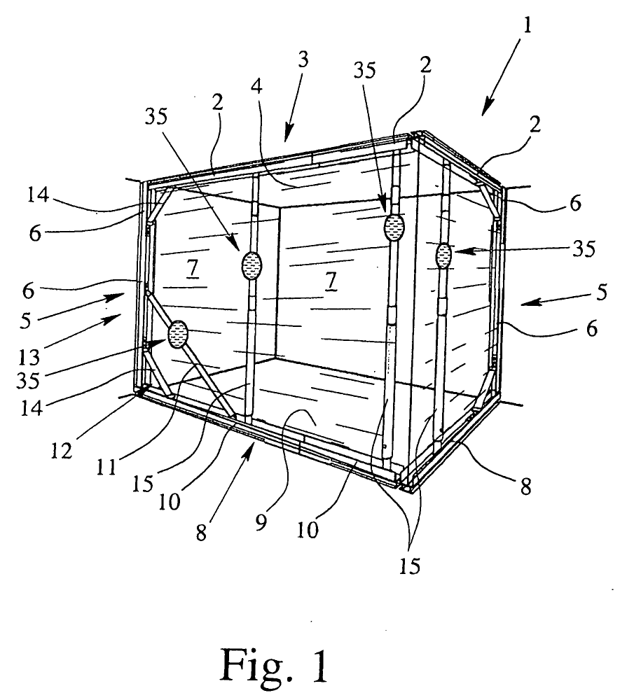

FIG. 1 shows a device 1 for dividing off areas of a space with a ceiling rail 3, having two ceiling rail parts 2, for pressing against the ceiling 4 of the space. The ceiling rail parts 2 have a profile such that adjacent ceiling rail parts 2 can be inserted into one another and can be pulled out relative to one another. As a result, the ceiling rail can simply have ceiling rail parts which can be telescoped into and out of one another, the ceiling rail parts being connected to one another simply by mutual insertion into one another, with the formation of a sliding connection. In the illustrated ceiling rail 3, the ceiling rail parts 2 are pulled out so far from one another that the ceiling rail 3 extends over the entire width of the ceiling 4 of the space. Here, it is provided that, in addition, the ceiling rail 3 is pressed over its entire length against the ceiling 4 of the space, and thus, along the entire length of the ceiling rail 3 adjoins the ceiling 4 of the space. It is equally possible for two adjacent ceiling rail parts 2 to be connected positively and/or nonpositively to one another by mutual superpositioning of the ceiling rail parts 2 in the lengthwise direction of the rail and by subsequent compression of the overlapping ceiling rail parts 2 in the transverse direction of the rail. After compression, then the ceiling rail parts 2 are at least essentially immovably connected to one another.

Adjacent ceiling rail parts 2 can also be connected to one another by way of connecting elements or profiles (not shown), so that a standard or integral ceiling rail results. The connection between the adjacent ceiling rail parts 2 can be such that relative displacement between the ceiling rail parts 2 is not possible. Adaptation to the width of the ceiling 4 of the space then takes place by way of ceiling rail parts 2 of different length which can be made available as a set.

Furthermore, FIG. 1 shows two wall rails 5 for supporting the ceiling rail 3. The wall rails 5 have two wall rail parts 6 which are connected to one another similarly to the ceiling rail 3. The wall rail 5 on the one hand is designed to press the ceiling rail 3 against the ceiling 4 of the space, and on the other hand, serves the purpose of adjoining the walls 7 over the entire length of the wall rail 5.

Moreover, FIG. 1 shows a floor rail 8 for resting on the floor 9 which has two floor rail parts 10. They are also connected to one another in the manner of the ceiling rail 3.

It is not shown in particular that, for very large areas of space to be divided off, the rails 3, 5, 8 can also have three and more rail parts 2, 6, 10. Alternatively or in addition, of course, it is also possible to use rail parts 2, 6, 10 which have different, preferably standardized lengths, so that depending on the dimensions of the space, rails 3, 5, 8 with different maximum and minimum lengths are available. By using rail parts 2, 6, 10 in a corresponding number and length, areas of space of any size can finally be divided off. Likewise, it is not shown in particular that the ceiling rail 3, the wall rail 5 and the floor rail 8 are made structurally identical.

In the device as shown in FIG. 1, there is at least one support rod 11 which is made as a diagonal brace for detachable fastening to the wall rail 5 and to the wall rail part 6, on the one hand, and the floor rail 8 and the floor rail part 10, on the other, the support rod 11 being provided outside of the corner region 12 between the wall rail 5 and the floor rail 8 for applying a contact force to the middle region 13 of the wall rail 5. The diagonally running support rod 11 is therefore provided in addition to the corner connectors 14 and provides for adequate contact pressure of the wall rail 5 against the wall 7 in the region between the corner connectors 14. Moreover, in FIG. 1 there are a plurality of vertically running support rods 15 which are located between the ceiling rail 3 and the floor rail 8 and which support them. The support rod 11, which is made as a diagonal brace, and the support rods 15, which are made as vertical braces, can be made the same or different. Each of the support rods 11, 15 is made telescoping and can be continuously adjusted in length by way of a corresponding connection. The support rod parts of the support rod 11, 15 are locked by turning the support rod parts relative to one another. Release takes place by turning in the opposite direction.

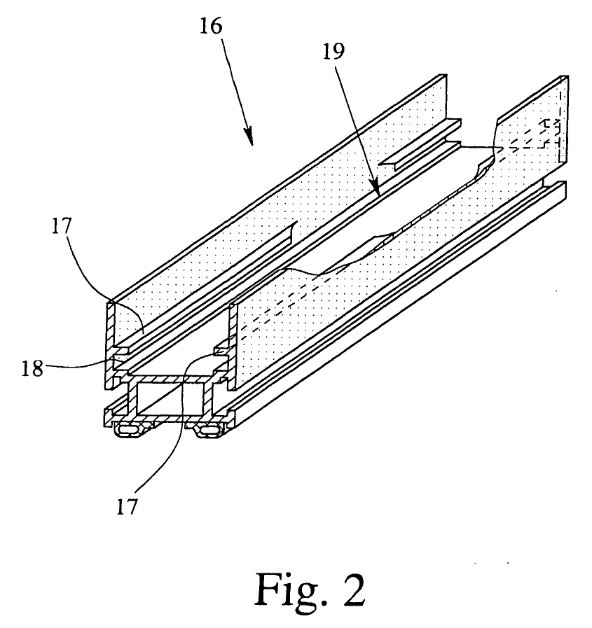

FIG. 2 shows a base profile 16 which can be used for the ceiling rail 3, the wall rail 5 and the floor rail 8. Underneath the extensions 17, there is a guide 18 which runs lengthwise and into which an end of a support rod 11, 15 can be inserted and can be braced there. As otherwise follows from FIG. 2, the guide 18 is interrupted on opposite sides roughly in the middle region. In the region of this interruption, there are no extensions 17 so that an insertion opening 19 is formed there.

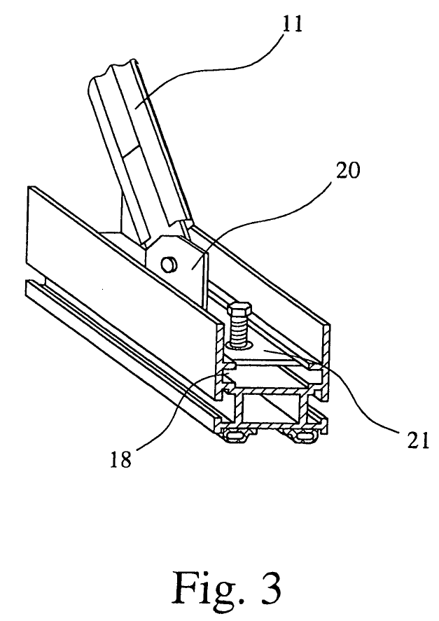

FIG. 3 shows that, for example, the ends of the support rod 11, which is made as a diagonal brace, has a coupled section 20 with a guide plate 21, the guide plate 21 being insertable into the guide 18. Different angular positions can be set by way of the coupled section 20. For bracing of the support rod 11, the guide plate 21 can be screwed in the guide 18 or, for example, can be clamped by a wedge.

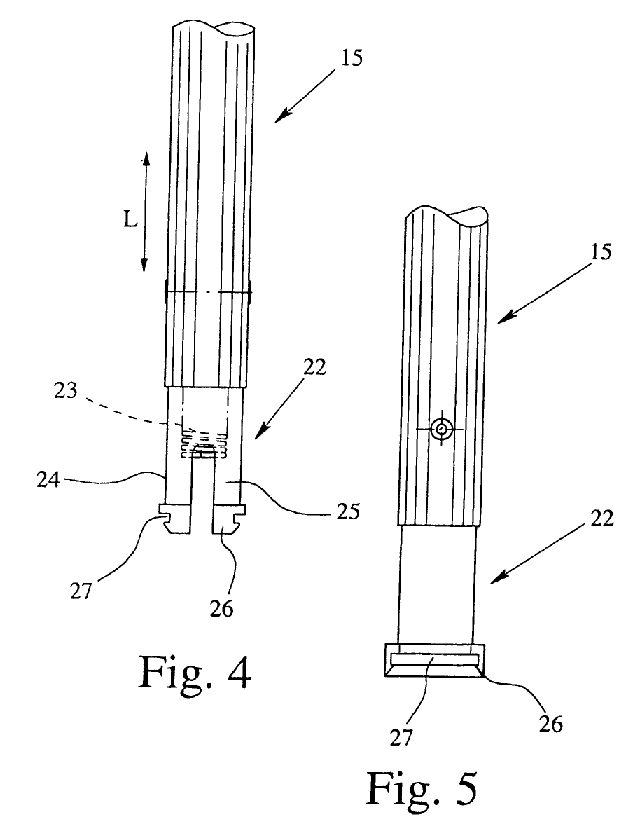

FIGS. 4 & 5 indicate that, for example, the support rod 15, which is made as a vertical brace, has a spring means 23 on its lower end 22 which acts in the lengthwise direction L. In this connection, a helical spring presses the lower end 22 to the outside. Otherwise, the lower end 22 of the support rod 15 can be locked into the base profile 16. For this purpose, the lower end 22 has two catch legs 24, 25 on whose ends one catch head 26 with one catch receiver 27 at a time is provided. The two receivers 27 are used for engaging the extensions 17 in the base profile 16. As a result of the catch connection, the lower end 22 of the support rod 15 can be locked anywhere in the base profile 16. For later removal from the base profile 16 it is necessary to move the support rod 15 either as far as one end of the base profile 16, or however, to remove the lower end 22 at an insertion opening 19.

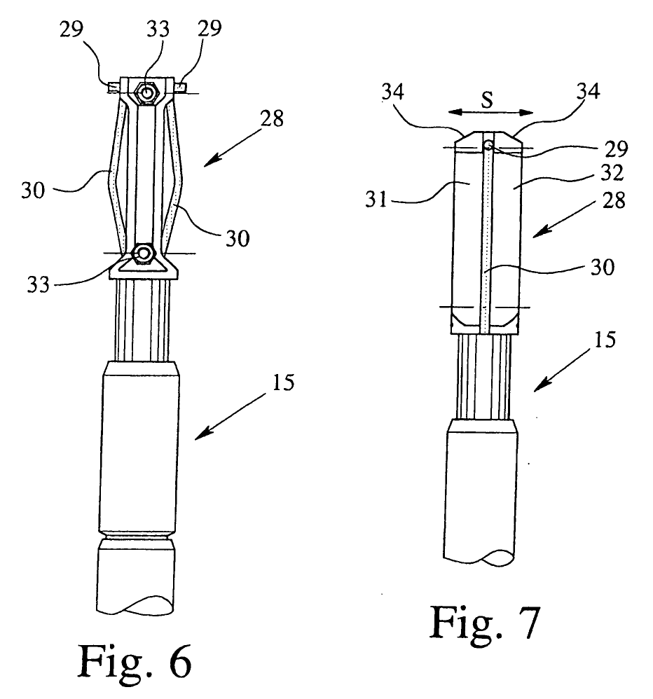

FIGS. 6 & 7 show the upper head 28 of the support rod 15. The support rod 15 can be inserted with its upper head 28 into the guide 18 of the base profile 16. Insertion can take place from the end of the base profile 16 or out of an insertion opening 19 as has been described above. The support rod head 28 has a guide projection 29 on each of opposite sides for engaging the guide 18. In the illustrated embodiment, guide projections 29 are made on the spring legs 30. The two spring legs 30 are part of a roughly U-shaped spring which is bulged in the middle region. In this way, it is possible to press the two spring legs 30 in the direction toward one another so that the outer ends of the guide projections 29 are held in the support rod head 28 and do not project over it. This makes it possible to insert the support rod head 28 anywhere into the base profile 16 since the width of the support rod head 28 is smaller than the spacing of the extensions 17 which are opposite one another in the base profile 16. Finally, the support rod head 30 has two head profiles 31, 32 which are screwed to one another by way of screw connections 33 with simultaneous fixing of the springs which have the spring legs 30.

Otherwise, the support rod head 28 is made such that, in the state inserted into the ceiling rail 3, pivoting of the ceiling rail 3 is possible relative to the lengthwise direction S of the rail on each side by at least 20°, preferably by more than 40°. For this purpose, the support rod head 28 is provided on the top side in the lengthwise direction S of the rail with a bevel 34 which declines to the outside, to either side. The respective bevel 34 ultimately comes to rest on the bottom of the guide 18 when the base profile 16 is in an inclined position.

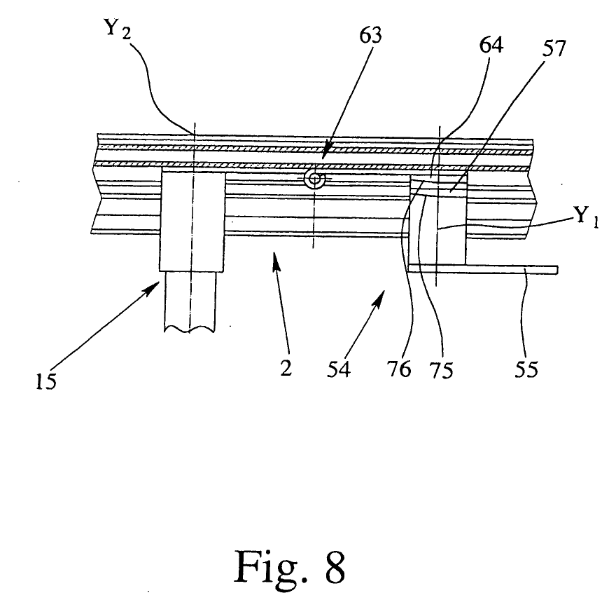

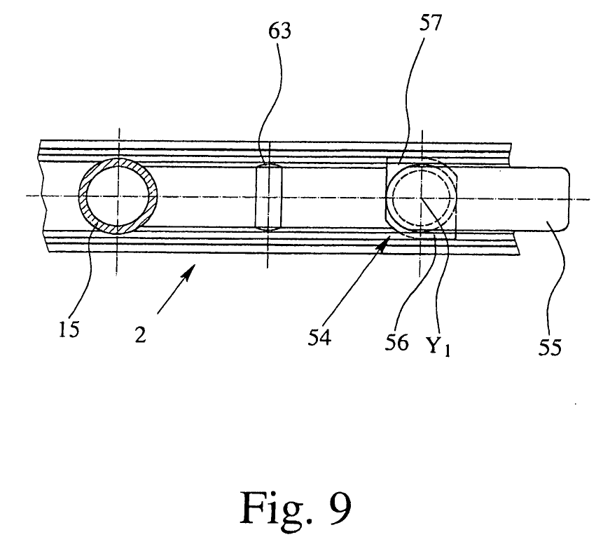

FIG. 8 shows a partial cross-sectional view of a support rod 15 which is attached to the ceiling rail part 2. The support rod 15, for example, has a fastening part 54 with a grip section 55 on the upper end. The fastening part 54 also has connecting means for positive and/or nonpositive connection to further complementary connecting means of the rail part 2, the connecting means of the fastening part 54 and the other connecting means of the rail part 2 being made such that simply by turning the fastening part 54 around its lengthwise axis Y₁, a frictional connection and/or a force-fit is effected in the profile of the rail part 2. When the grip section 55 turns, the projections 56, 57 shown in FIGS. 8 & 9 and the other projection 64 as well as another projection of the fastening part 54 (not shown) engage the engagement regions 59, 60 and other engagement regions 61, 62 of the rail part 2, which will be in detail below. In this connection, it is such that the connecting means of the fastening part 54 correspond to the connecting means of the support rod 15 which are provided on the lower end of the support rod 15 for positive and/or nonpositive connection of the support rod 15 to the rail part 2.

FIGS. 8 & 9, moreover, show that the support rod 15 and the fastening part 54 are hinged to one another by a hinge 63 so that it is possible to pivot the support rod 15 relative to the rail part 2 after attachment of the fastening part 54 with the ceiling rail 3. In this way, attachment of the support rod 15 with the free end to the floor rail 8 is facilitated.

After attaching the fastening part 54 to the rail part 2, the support rod 15 is moved into the vertical position, and then, by turning around the lengthwise axis Y₂ with its lower end, is fastened in the rail part 10 of the floor rail 8. The rail parts 2 of the ceiling rail 3, on the one hand, and the rail parts 10 of the floor rail 8, on the other, are made the same. Fundamentally, the support rod 15 can therefore also be attached using the fastening part 54 to a floor rail 8 or to a wall rail 4.

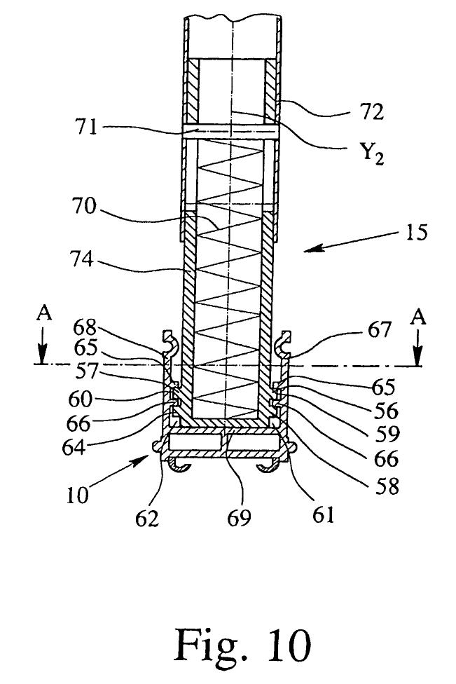

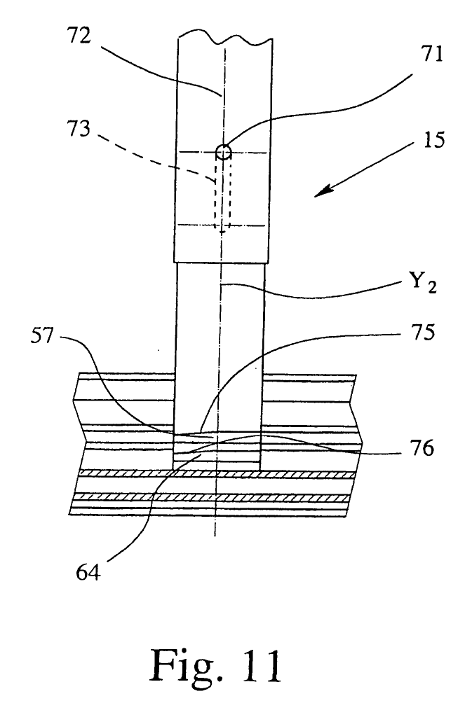

FIG. 10 shows the free end of the support rod 15, the support rod 15 being tightly connectable to the rail part 10 by turning. To do this, the support rod 15, on its free end, has projections 55, 57 and other projections 58, 64 which correspond to the projections on the fastening part 54. The projections 56, 57 engage the engagement regions 59, 60 of the rail part 10, while the other projections 58, 64 engage the other engagement regions 61, 62. The rail part 10 has oppositely arranged projections 65, 66 with the same width. The projections 65, 66 are provided on the inner sides of the side walls 67, 68 of the rail part 10. The projections 65, 66, on the one hand, and the projection 66 and the bottom 69 of the rail part 10, on the other, border the engagement regions 59, 60 and the other engagement regions 61, 62. As has already been pointed out, the lower end of the support rod 15 shown in FIG. 8 and the upper end of the fastening part 54 which is intended for attachment to the rail part 2 are made the same; this makes it possible, with the same execution of the rail parts 2 of the ceiling rail 3 and the rail parts 10 of the floor rail 8 to attach the fastening part 54 or the free end of the support rod 15 to the ceiling rail 3 or the floor rail 8 if necessary.

FIGS. 10 & 11 also show that the support rod 15 has a spring means 70 in the region of the free lower end which acts in the lengthwise direction Y₂ of the support rod 15 and a retaining pin 71 which acts against the spring means 70, the retaining pin 71 being tightly connected to the tubular outer part 72 of the support rod 15 and being movably guided in a slot 73 of the tubular inner part 74 of the support rod 15. In this way, the support rod 15 can be easily braced between the ceiling rail 3 and the floor rail 8.

The projections 56, 57 and the other projections 58, 64 in the lengthwise direction of the rail part 2, 10 have feed bevels 75, 76 which are inclined in the direction to the bottom 69 of the rail part 2, 10. The feed bevels 75, 76 facilitate screwing of the projections 56, 57 and the other projections 58, 64 into the engagement regions 59, 60 and the other engagement regions 61, 62 of the rail part 2, 10.

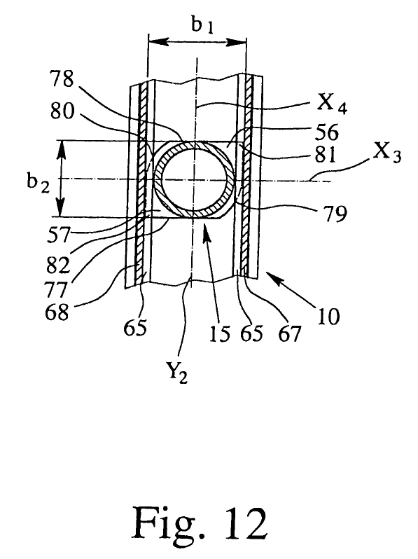

FIG. 12 shows that the two projections 56, 57 which are located in a common plane, on the one hand, and the other projections 58, 64, on the other (not shown here), span a cross-sectional area with two straight outer sides 77, 78 which are located oppositely parallel and with two arc segment-shaped outer sides 79, 80 which are located diagonally opposite. The other projections 58, 64 are made corresponding to the projections 56, 57. The cross-sectional area, moreover, has two diagonally opposite edges 81, 82 with outer sides 78, 79 and 77, 80 which run essentially at a right angle to one another, after connecting the support rod 15 to the rail part 10 by turning the support rod 15 the projections 56, 57 at least in the region of the edges 81, 82 resting against the side walls 67, 68 of the rail part 10. The maximum width b₁ of the cross-sectional area in the region of the middle transverse axis X₁ of the support rod 15 corresponds essentially to the distance between the adjacent side walls 67, 68 of the rail part 10. The minimum width b₂ of the cross-sectional area in the direction of the middle transverse axis X₂ is conversely smaller than the distance between the projections 65 of the rail part 10. In this way it is easily possible in the first rotary position of the support rod 15 to insert it with its free end into the region between the opposing projections 65 of the rail part 10 and by turning at least the inner part 74 of the support rod 15 around the lengthwise axis Y₂ into a second rotational position to produce a positive and nonpositive connection between the support rod 15 and the rail part 10. It goes without saying that the intended type of connection between the support rod 15 and the rail part 10, on the one hand, and the connection of the fastening part 54 to the rail part 2, on the other, presuppose that the support rod 15 has at least two support rod parts 72, 74 which can be turned relative to one another around the common lengthwise axis Y₂.

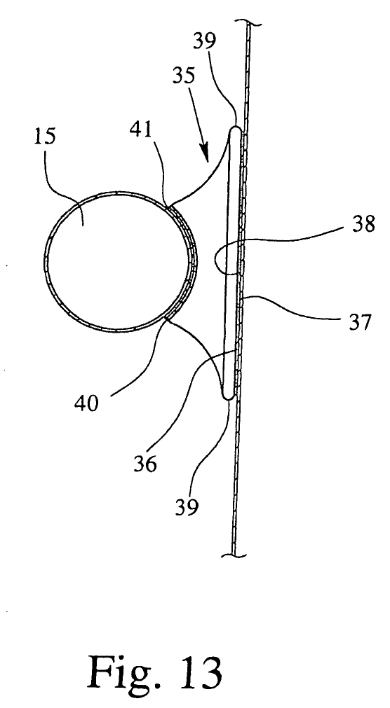

FIG. 13 shows a cross-sectional view through a vertically running support rod 15 which is shown in FIG. 1 and which on the lengthwise side has a surface element 35 with a fastening surface 36 for a web 37 of film or fabric. The fastening surface 36 on the outer side has a fastening means 38 which is made as an adhesive layer for attaching the web 37 of film or fabric to the fastening surface 36. As is shown in FIG. 1, the surface element 35 is aligned such that the fastening surface 36 is aligned essentially perpendicular to the floor 9 and parallel to one wall 7. The surface elements 35 make it possible to fix the web 37 of film or fabric 37 which is otherwise attached to the ceiling rail 3, the floor rail 8 and the wall rail 5 additionally by attachment to the support rod 15 in the region between the rails 3, 5, 8. This contributes to reliably dividing off an area of a space without the tearing of the web of film or fabric having to be feared.

The surface element 35 is adjustable in height and is detachably connected to the support rod 15. To be able to preclude tearing of the web 37 of film or fabric, the surface element 35, at least in the region of the fastening surface 36, has rounded edges 39. As FIG. 1 shows, the fastening surface 36 has an essentially round shape. Fundamentally, the fastening surface 36, however, can also have a shape which differs from a round shape.

The surface element 35 on its side facing the support rod 15 has a bulge 40 with a concave recess, the inside radius of the recess of the bulge 40 being matched to the radius of the support rod 15 in order to be able to reliably connect the surface element 35 to the support rod 15. On the outside of the bulge 40, and at least in regions on the outside of the support rod 15, there are connecting means 40, 41 which form a VELCRO® hook and loop type connection. The connecting means 41 on the outside of the support rod 15 can be provided in the lengthwise direction at different locations of the support rod 15 in order to be able to connect the surface element 35 if necessary to the support rod 15 at a different height.

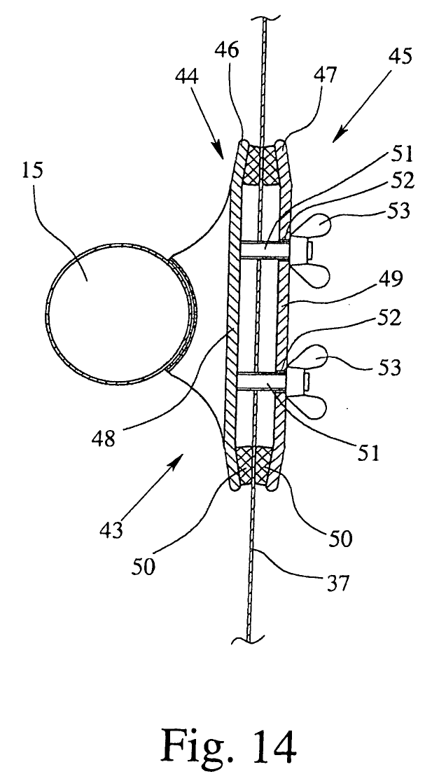

The surface element 43 which is shown in FIG. 14 has two fastening parts 44, 45. The fastening parts 44, 45 are made dish-shaped with a conical ring shell as the dish edge 46 and 47 and an essentially flat base plate as the dish bottom 48 and 49.

To attach the web 37 of film or fabric to the support rod 15 it is provided that the web 37 of film or fabric be clamped between the fastening parts 44, 45. In order to ensure reliable bracing without tearing of the web 37 of film or fabric, in the region of the dish edge 46, 47 there is a foam coating 50 in the shape of an annular disk.

In order to brace the fastening parts 44, 45 relative to one another and to be able to clamp the film 37 between the fastening parts 44, 45, on the inner fastening part 44, there are threaded bolts 51 which are pointed to the outside and which extend through attachment holes 52 of the outer fastening part 45. The outer fastening part 45 is pressed against the inner fastening part 44 by wing nuts 53 which are screwed onto the threaded bolts 51. For clamping the web 37 of film or fabric between the fastening parts 44, 45, it is thus necessary to press the web of film or fabric initially against the first fastening part 44. Then, the outer fastening part 45 is slipped onto the threaded bolt 51 and braced against the inner fastening part 44 by tightening the wing nuts 53.

1-18. (canceled)

19. Device for dividing off areas of a space, comprising:
at least one ceiling rail,
at least one floor rail
at least one wall rail (5),
at least one web of film or fabric which is connectable to the at least one ceiling rail, at least one floor rail and at least one wall rail,
at least one support rod for placement between a ceiling rail or floor rail and a wall rail, and
at least one surface element on a lengthwise side of the at least one support rod which has a fastening surface for the web of film or fabric, and which is adjustable in height relative to the support rod, the fastening surface being on a front of the surface element, the surface element having at least one fastening means for attaching the web of film or fabric to the fastening surface and the surface element being alignable such that the fastening surface is located essentially perpendicular to a floor of the area of space which is to be divided off.

20. Device as claimed in claim 19, wherein the surface element is detachably connected to the support rod.

21. Device as claimed in claim 19, wherein the surface element has rounded edges at least in a region of the fastening surface.

22. Device as claimed in claim 19, wherein the surface element is dish-shaped or plate-shaped.

23. Device as claimed in claim 19, wherein the fastening surface has an adhesive layer thereon.

24. Device as claimed in claim 19, wherein further comprising at least one connecting means for detachable joining of the surface element to the support rod and wherein the connecting means is on a back side of the surface element.

25. Device as claimed in claim 19, wherein the surface element is formed of a plurality of parts and has at least two fastening parts which are attachable to one another, each of the fastening parts having a fastening surface on a side thereof which faces the other so that the web of film or fabric can be attached between the fastening parts.

26. Device as claimed in claim 25, wherein the at least two fastening parts are dish-shaped with a conical ring shell as an edge of the dish and with a flat base plate as the bottom of the dish, and wherein the fastening surface is in the region of the edge of the dish. At

27. Device as claimed in claim 25, further comprising tension means for detachable bracing of the fastening parts relative to one another.

28. Device as claimed in claim 25, wherein the at least two fastening parts have an elastic coating with a low indentation hardness, and wherein the coating is provided at least in an edge region of the fastening parts.

29. Device as claimed in claim 25 wherein one of the fastening parts has at least one connecting means for detachable connection of the surface element to the support rod.

30. Device as claimed in claim 19, wherein at least one end of the at least one support rod has at least one connecting means for connection of thereof to complementary connecting means of the rails and wherein the connecting means of the support rod and the connecting means of the rails are adapted to produce a frictional or force fit connection in a profile of the rail simply by turning the support rod around a lengthwise axis thereof.

31. Device as claimed in claim 19, wherein at least one end of the at least one support rod has a fastening part pivotally connected thereto, the fastening part having connecting means for connection to complementary is connecting means of the rails and the connecting means of the fastening part and the connecting means of the rails being adapted to produce a frictional or force fit connection in a profile of the rail simply by turning the support rod around a lengthwise axis thereof.

32. Device as claimed in claim 31, wherein at least one of the at least one support rod and the fastening part has at least one projection on at least one end thereof as the connecting means and wherein the projection is insertable into an engagement region of the complementary connecting means of the rail by turning one of the support rod and the fastening part around a lengthwise axis thereof.

33. Device as claimed in claim 19, wherein in the support rod, on at least one end, has at least one spring means which acts in a lengthwise direction of the support rod.

34. Device as claimed in claim 19, wherein at least one end of the support rod with is lockable into at least one of the floor rail and the ceiling rail.

35. Device as claimed in claim 19, wherein a head of the support rod head, in a state inserted into a respective one of the rails, is pivotable relative to the respective rail relative to the lengthwise direction of the rail by at least 200 in each of opposite directions relative to the support rod.

36. Device as claimed in claim 19, wherein a head of the support rod head, in a state inserted into a respective one of the rails, is pivotable relative to the respective rail relative to the lengthwise direction of the rail by at least 40° in each of opposite directions relative to the support rod.

37. Device as claimed in claim 35, wherein a top end of the support rod head has at least one bevel or rounding in a lengthwise direction of the rail.
